(19) United States
(12) Patent Application Publication
(10) Pub. No.: US 2005/0236498 A1
(43) Pub. Date: Oct. 27, 2005

(54) Systems and methods for dispensing liquids

(76) Inventor: Greg A. Cunningham, Baton Rouge, LA (US)

Correspondence Address: SIEBERTH & PATTY, LLC, 4703 BLUEBONNET BLVD, BATON ROUGE, LA, 70809, US

(21) Appl. No.: 11/048,945

(22) Filed: Feb. 2, 2005

Related U.S. Application Data
(60) Provisional application No. 60/565,609, filed on Apr. 27, 2004.

(51) Int. Cl. B05B 7/32

(52) U.S. Cl. 239/313

(57) ABSTRACT

A system for applying a liquid chemical mixture to an area. The system comprises: a liquid conduit for supplying a flow of pressurized liquid to the system, which pressurized liquid enters the conduit through an inlet valve; a container for a liquid chemical composition, which container is in fluid communication with the conduit so that the composition contacts the pressurized liquid in the conduit to form the mixture; a reservoir in fluid communication with the conduit, which reservoir is configured to receive and store the mixture, at least one spray nozzle, through which spray nozzle, the mixture is dispensed to the area; a pump in fluid communication with the reservoir and with the spray nozzle, which pump forces the mixture through the spray nozzle; and an automated controller which is configured to at least (i) control operation of the inlet valve and (ii) control operation of the pump. Methods for dispensing a liquid chemical mixture to an area are also described.

### REFERENCE TO RELATED APPLICATION

This application claims the benefit of U.S. Provisional Patent Application No. 60/565,609, filed Apr. 27, 2004, the disclosure of which is incorporated herein by reference.

### FIELD OF THE INVENTION

This invention relates generally to systems for dispensing liquids, and specifically to systems for spraying liquid chemical mixtures, as well as related methods.

### BACKGROUND

Agricultural, horticultural, livestock or forestry sprayer systems are known that include a reservoir for supplying a diluent and a spray head for spraying a mixture of the diluent and a chemical concentrate. The chemical concentrate is supplied from a separate container, and the chemical must be diluted prior to use with a diluent, generally water. The container is subsequently rinsed with the diluent and is discarded. This dilution operation, commonly performed manually, is unsatisfactory because of the risks of having the chemical concentrate spilled and/or having the chemical mixed at the wrong concentration, both of which could result in adverse environmental consequences. Such manual handling of the chemical concentrate also presents a danger of prolonged exposure of the handler to the chemical.

Other known dispensing systems are controlled by timers set up to provide timed dispensing of chemicals to sprayer arrays, though these systems have limitations of choice of spray times and duration. These timers are also very difficult and time consuming to set up. With these dispensing systems, the concentrate is mixed manually in large containers making them susceptible to errors in the concentration of the sprayed chemical.

Thus a need exists for an integrated automated system which provides precise dilution of concentrated chemical formulations with minimal user contact and for a system which provides timed control of sprayer application of liquid chemical mixtures such as, but not limited to, pesticides and insecticides, to designated areas so as to minimize environmental contamination and hazards for the user. A need also exists for an integrated system which operates in a manner capable of great variability and ease of use to the timing needs of the user, while performing in a highly economical manner.

### SUMMARY OF THE INVENTION

The present invention meets these and other needs by providing, among other things, a novel, integrated, automated system which operates to both form a diluted chemical mixture and also dispense the mixture to a designated area through one or more spray nozzles. The system exhibits highly desirable flexibility for automated control of frequency and duration of the spray. In an insect control situation, the present system allows lesser frequency and/or duration of spray when undesirable pests are not in evidence and greater frequency and/or duration during peak times of insect activity (for instance, at dusk and dawn). Integrated into this novel system are a number of alarms, notification mechanisms and shut-down features which interact to ensure the safety of both the user and the environment.

The present invention provides a system for applying a liquid chemical mixture to an area. The system comprises: (A) a liquid conduit for supplying a flow of pressurized liquid to the system, which pressurized liquid enters the conduit through an inlet valve; (B) a container for a liquid chemical composition, which container is in fluid communication with the conduit so that the composition contacts the pressurized liquid in the conduit to form the mixture; (C) a reservoir in fluid communication with the conduit, which reservoir is configured to receive and store the mixture; (D) at least one spray nozzle, through which spray nozzle, the mixture is dispensed to the area; (E) a pump in fluid communication with the reservoir and with the spray nozzle, which pump forces the mixture through the spray nozzle; and (F) an automated controller which is configured to at least (i) control operation of the inlet valve and (ii) control operation of the pump.

Another embodiment of the invention provides a method for dispensing a liquid chemical mixture to an area, which method comprises:
(A) introducing a flow of pressurized liquid through an inlet valve into a liquid conduit;
(B) placing the liquid conduit in fluid communication with a container for a liquid chemical composition, which container is sized and configured such that the composition contacts the pressurized liquid and forms the mixture in the liquid conduit as the pressurized liquid flows though the liquid conduit;
(C) moving the mixture so formed into a reservoir in fluid communication with the liquid conduit;
(D) periodically pumping the mixture from the reservoir through at least one spray nozzle into the area by use of a pump, which pump is in fluid communication with the reservoir and with the spray nozzle; and
(E) controlling at least operation of the inlet valve and the pump by use of an automated controller.

As used herein the phrases “placing in fluid communication with” and “in fluid communication with” signify that some means of connecting the designated elements is employed, such as tubes, lines, conduit, pipes, manifolds or the like, as long as fluid can pass between the designated elements.

These and other embodiments, advantages, and features of this invention will be apparent from the following description, accompanying drawings and appended claims.

### BRIEF DESCRIPTION OF THE DRAWINGS

FIG. 1A is a partial cross-sectional, side view of the system of an embodiment of the present invention, showing the direction of fluid flow when the system is dispensing a liquid mixture.

FIG. 1B is substantially the same as FIG. 1A showing possible direction of fluid flow when the pump is inactive.

FIG. 2 illustrates an embodiment of the invention similar to the view of FIG. 1, in which the system comprises a container for liquid chemical composition having an interlocking top portion.

FIG. 3 is a perspective view of a spray nozzle of the invention.

FIG. 4 is a top plan view of the user interface of an automated controller of a preferred embodiment of the invention.

FIG. 5 is a perspective view of an environment sensor of a preferred embodiment of the invention.

FIG. 6 presents a partial cross-sectional, side view of a system of another embodiment of the present invention.

In each of the above figures, like numerals or letters are used to refer to like parts among the several figures.

### DETAILED DESCRIPTION OF THE INVENTION

Embodiments of the present invention comprise systems, apparatus and methods to control the forming and dispensing of liquid chemical mixtures to residential, industrial, commercial and animal-related areas. Types of operations which may require application of such liquid chemical mixtures include, but are not limited to, spraying of fertilizers, growth stimulants, herbicides and the like to any one of a large number of agricultural or horticultural areas, direct spraying of pesticides and germicides onto livestock and pets as well as spraying these products in areas where such animals are held or housed, and spraying insecticides and pesticides in and around buildings, industrial, commercial and residential, for one or more types of insects, arachnids and other pests. The systems and methods of this invention provide a highly desirable integrated, automatically controlled function of formation of a liquid chemical mixture and dispensation of the mixture though one or more spray nozzles disposed in the area where such application is desired. Surprising ease of maintenance in a preferred embodiment of the system is attained by providing a container for a concentrated chemical composition which comprises an interlocking top or cap portion configured to be quickly attached and detached from a conduit's liquid flow path of the system. Other preferred embodiments of the invention provide highly adaptable, multiple variable automated controller components so that the system accomplishes a novel degree of flexibility for adjusting spray frequency and duration.

Surprisingly, embodiments of the invention provide assurance that a number of undesirable operation conditions are automatically controlled and/or avoided. Some situations that are automatically controlled and/or avoided are: the system does not overfill the reservoir resulting in a spill of liquid mixture; the pump does not drain the reservoir to a dry or empty condition with likely damage to the pump; liquid flow of the system is not permitted to reenter and contaminate the water supply; the system maintains its effectiveness by providing proper concentrations of liquid mixture; the amount of liquid chemical composition cannot be completely depleted within the container without warning of low levels being provided to the user and the system shutting down; spray nozzles are provided that comprise check valves to prevent chatter and dripping after shut down; and pressure on spray nozzles is quickly released by activation of a dump valve to permit liquid to flow back into the reservoir upon pump shut-down.

It will now be appreciated that the formation of a liquid chemical mixture of a liquid additive, such as an insecticide, and a pressurized liquid is provided by a system which also provides a reservoir (for storing and dispensing the liquid mixture), an automated controller, a pump, a dump valve (for relieving back pressure), and one or more spray nozzles (having check valves). The system provides an environment-conscious, economical system for dispensing useful and desirable liquid additive mixtures, such as but not limited to, insecticides, to various areas. Use of the dump valve and check valves ensures that delivery of precisely the desired amount of liquid additive mixture through the spray nozzles is accomplished without wasteful and environmentally undesirable leakage and dripping of the mixture. Furthermore, a preferred embodiment of the present invention is sized and configured to be compact and easily maintained.

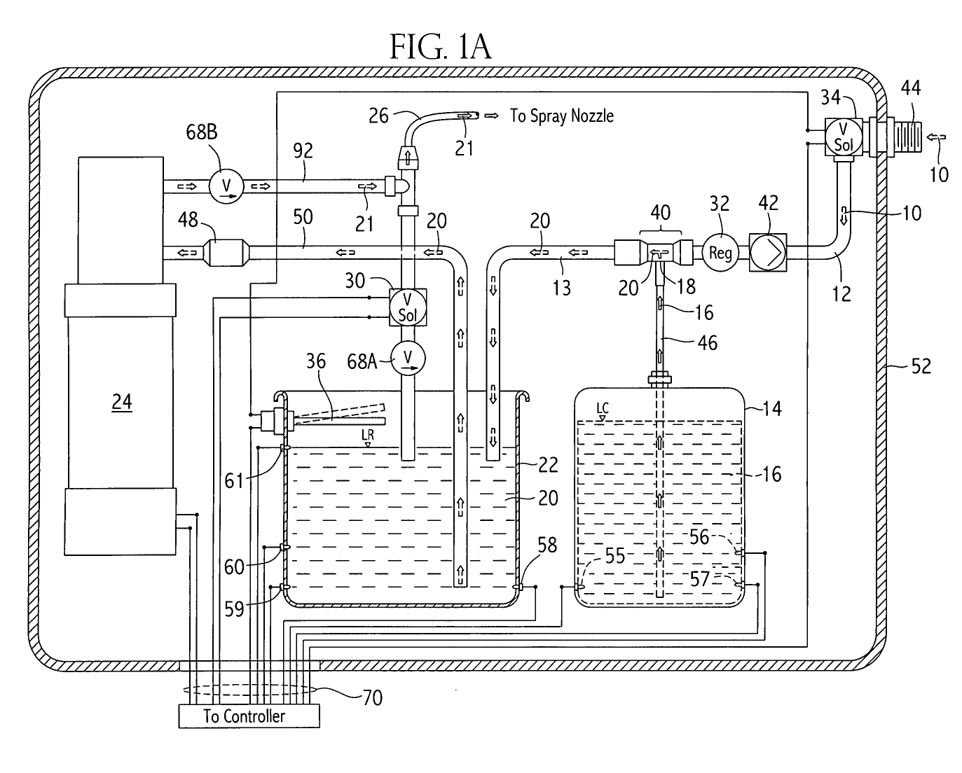

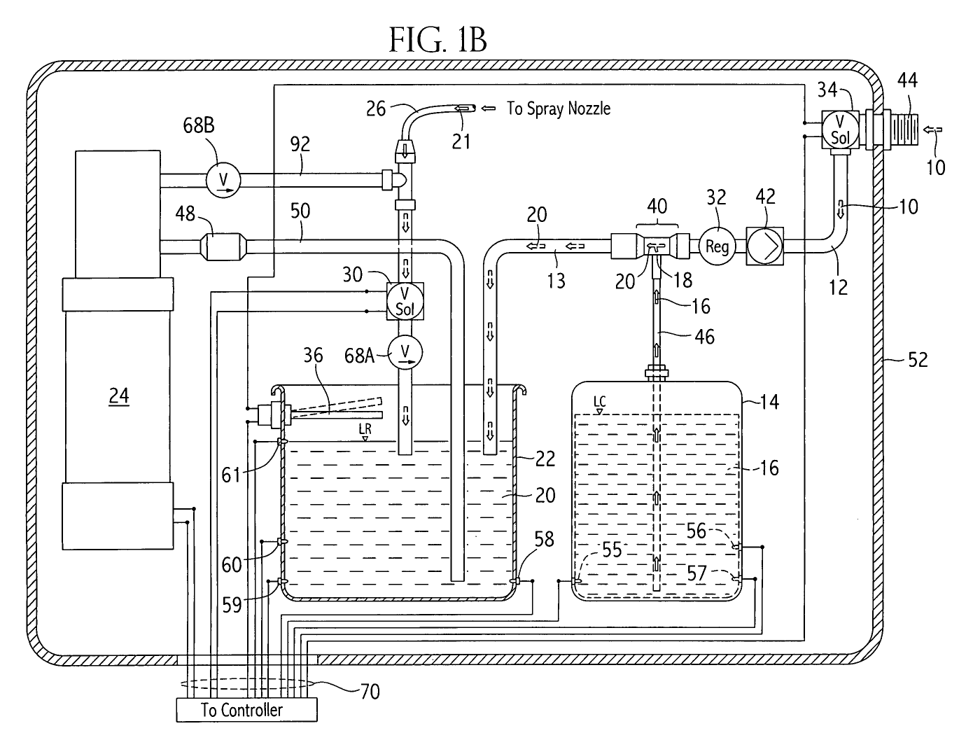

Features and methods of this invention will now be described by reference to the Figures. A preferred embodiment of the invention, depicted in FIG. 1A, provides a liquid conduit 12 for a pressurized liquid 10 in fluid communication with a container 14 for a liquid additive, herein depicted as a liquid chemical composition 16. Pressurized liquid 10 is moved into the system through a pressurized liquid supply conduit 44, shown here as a threaded coupling for an ordinary garden hose (not shown), in fluid communication with a conventional source of such liquid. This can also be a permanent connection to a source of pressurized liquid. In a preferred embodiment shown, pressurized liquid 10 is water. Typically, the flow of pressurized of water is supplied from a municipal water supply.

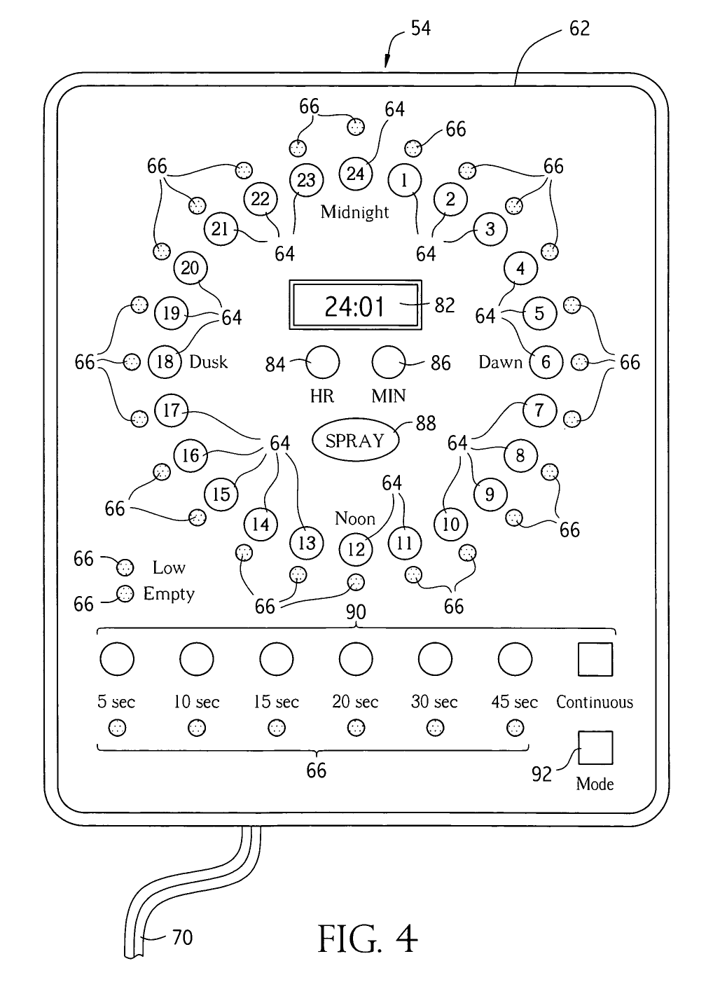

Pressurized liquid 10 enters conduit 12 through an inlet valve 34, depicted as a solenoid valve, having electrical connections or circuit lines 70,70, to an automated controller (as seen in FIG. 4). Inlet valve 34 is one component of an automated control system which controls activation and operation of the system. Inlet liquid 10 pressures in the range of about 10 psi to about 100 psi are preferred. When such inline condition of a system component is observed it is to be understood that fluid communication between components has been or can be established.

Operation of the system commences by supplying electrical power to the automated controller and system, and initializing pressurized liquid flow to the system.

Liquid conduit 12 comprises a venturi-shaped section 40 for forming a vacuum therein which is in fluid communication with a container 14 for liquid chemical composition 16 by way of liquid chemical composition supply line 46. When inlet valve 34 activates to allow entry of pressurized liquid 10 into liquid conduit 12, the movement of pressurized liquid 10 through venturi-shaped section 40 causes a decrease in pressure, or vacuum, across aperture 18 of liquid chemical composition supply line 46, which aperture 18 is defined by the walls of venturi-shaped section 40. Direction of liquid flow is depicted by arrows. As a result of the decreased pressure across aperture 18 and vacuum in venturi-shaped section 40, liquid chemical composition 16 is drawn from liquid chemical composition container 14 into venturi-shaped section 40.

Liquid chemical composition 16, as drawn into venturi-shaped section 40, mixes with the flow of pressurized liquid 10 forming a liquid mixture 20 of chemical composition and water in venturi-shaped section 40 and/or in downstream conduit 13. Internal diameters of venturi-shaped section 40 determine the volume ratios of composition 16 to pressurized liquid 10 so as to attain desirable and consistent concentrations of mixture 20. Suitable venturi-shaped sections can have varying internal diameters of aperture 18 of composition supply line 46 depending on the desired ratio of chemical to diluent that is required for each particular application. Preferred internal diameters of aperture 18 are in the range of about 0.04 inches to about 0.06 inches. Use of a venturi-shaped section having a different internal diameter will result in changing the ratio of composition to pressurized liquid. Preferred diameters of the venturi-shaped section at its narrowest span range from about 0.08 inches to about 0.12 inches. Pressure regulating valve 32, inline with flow of pressurized liquid 10 in conduit 12, is configured to provide a regulated flow of liquid in the range of about 1.2 to about 1.8 gallons per minute.

Level sensors 55,56,57 are seen integrated into container 14 and positioned to that when liquid level LC of chemical composition 16 falls below sensor 56, continuity is broken between sensor 56 and sensor 55 thus sending an electronic signal to an automated controller (shown best in FIG. 4). The low level situation will trigger audible and/or visual alarms, thus alerting the user that he will need to replace and/or refill container 16 soon. When liquid level LC of chemical composition 16 falls below sensor 57, continuity is broken between sensor 57 and sensor 55 sending a signal to an automated controller (shown best in FIG. 4). Under this condition inlet valve 34 will be disabled to prevent incorrect dilutions of mixture 20. The empty level situation will also trigger audible and/or visual alarms, thus alerting the user that the system is out of chemical and that he will need to replace and/or refill container 16 before the system will spray again. This provides a mechanism to lessen the likelihood that ineffective concentrations of mixture 20 will be dispensed.

One of numerous environmental safety features provided by the present invention comprises a back flow preventor 42 inline with conduit 12, which prevents any liquid mixture 20 or liquid chemical composition 16 from being inadvertently permitted to flow back into and contaminate the pressurized liquid flow source 10, such as a municipal water supply.

Liquid mixture 20 passes through liquid conduit 13 and into reservoir 22. Reservoir 22 is sized and configured to serve as repository and storage site for mixture 20 and a source of mixture 20 to be eventually dispensed onto an area such as, but not limited to, residential, industrial, and animal-related areas which are susceptible to pest infestations and therefore are in need of an application of insecticide, or the like.

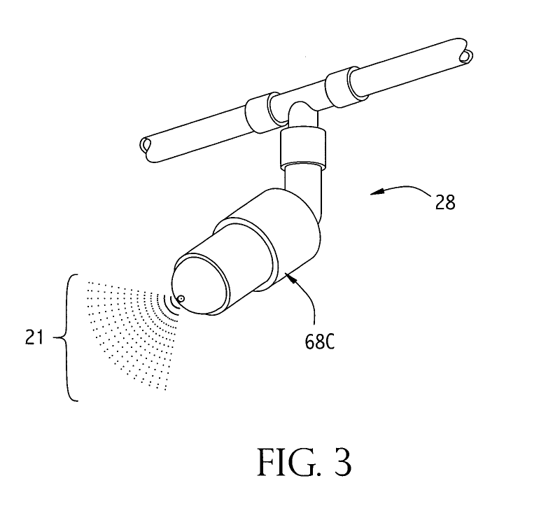

Reservoir 22 is further in fluid communication with pump 24 by way of reservoir outlet line 50. Pump 24 is shown as a centrifugal pump in fluid communication with reservoir 22 by way of pump inlet line 50 and with a spray nozzle conduit 26 by way of pump outlet line 92. An inline filter housing 48 is shown to be disposed in pump inlet line 50. A filter (not shown) in filter housing 48 serves to remove any unwanted particulates or solid matter from the fluid stream, thus preventing plugging of pump 24 or downstream spray nozzles (best seen in FIG. 3). Pump 24 discharges filtered mixture 21 at an elevated pressure through pump outlet line 92. A preferred pressure range for the discharge pressure of pump 24 is in the range of about 40 to about 3000 psi, with a range of about 180 psi to about 250 psi being particularly preferred. Pump 24 is designed to provide self-regulating pressure independent of the volume of liquid pumped. Filtered liquid mixture 21, under increased pressure, moves from pump 24 through pump outlet line 92 and spray nozzle conduit 26 to at least one spray nozzle (best seen in FIG. 3). Preferred embodiments of the invention provide positive displacement pumps, such as, piston pumps, centrifugal pumps, and diaphragm pumps, with piston pumps being preferred.

Referring now to FIG. 1B, check valve 68A is a one-way check valves that allows liquid under higher pressure to flow back from the spray nozzles into reservoir 22 but is set to maintain liquid in the lines even when pump 24 is not in operation so that prime to pump 24 is maintained. Check valve 68B is set at about 3 psi, while check valve 68A is maintained at a setting in the range of about 10 psi to 50 psi. In addition, check valve 68C seen on FIG. 3, has a setting of about 80 psi to about 100 psi to prevent chatter and/or dripping of spray nozzle 28 when the system is shut down or otherwise not active. During normal operation of the system with pump 24 operating, solenoid dump valve 30 is closed so that no fluid pressure is applied to check valve 68A, as best seen in FIG. 1A. However, when pump 24 is inactive or turned off, solenoid dump valve 30 opens to allow higher pressure liquid mixture 21 to flow through check valve 68A into reservoir 22 until the pre-set pressure setting of check valve 68A is attained. This allows high pressure to be relieved from spray nozzle 28 to prevent chatter and dripping, and also maintains liquid in the lines during periods when the system is inactive. Check valve 68B prevents pressurized liquid mixture 21 from flowing back into pump 24.

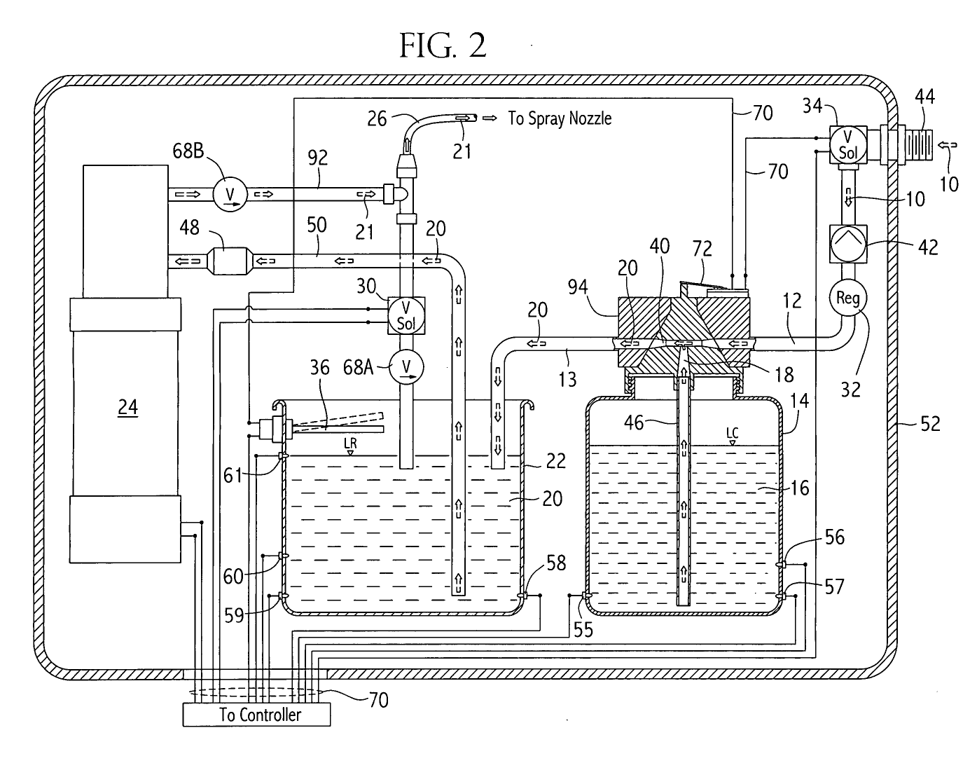

An embodiment of the invention, as seen in FIGS. 1A, 1B and 2, provides a reservoir overflow prevention protocol having a redundancy back-up feature, depicted as level control device 36. Level sensors 58,59,60,61 are seen disposed in the wall of reservoir 22 at several carefully chosen points. The upper level sensor 61 detects when level LR of mixture 20 reaches a pre-set high level which establishes continuity between sensor 61 and sensor 58. Sensor 61 sends an electronic signal to the automated controller (seen in FIG. 4) along electrical circuit lines 70,70. The automated controller is configured to receive the high liquid level signal and deactivate intake valve 34 to prevent additional mixture flow into reservoir 22. The automated controller also comprises a redundant level control device 36 which detects when the level LR of mixture 20 in reservoir 22 reaches an undesirably high level indicating the failure of sensor 61. Level control device 36 is electrically connected to inlet valve 34 and the automated controller so that inlet valve 34 will be shut to prevent an overflow condition of reservoir 22 from developing.

As the pump causes the mixture to spray through the nozzles, the level of liquid mixture 20 will fall in the reservoir. When level LR of mixture 20 drops below an intermediate level, continuity is broken between sensor 60 and sensor 58 thus sending an electronic signal to the automated controller that level LR is below a preferred minimum level. The automated controller will cause inlet valve 34 to open, thus providing additional mixture to flow into reservoir 22. Flow of mixture 20 into reservoir 22 continues until liquid level LR reaches upper level sensor 61 thus establishing continuity between sensor 58 and sensor 61. The automated controller will then cause inlet valve 34 to close. If the water supply to inlet valve 34 is somehow interrupted and pump 24 continues to remove mixture 20 from reservoir 22, the liquid level in reservoir 22 will drop below a lower level, monitored by lower level sensor 59 thus continuity will be broken between sensor 59 and sensor 58. Under this condition, the automated controller will cause pump 24 to shut down to prevent cavitation and eventual damage to the pump. The automated controller will also emit an audible signal and/or a visual alarm to alert the user to the undesirable condition.

Thus, a preferred embodiment of the invention provides that the reservoir comprise a plurality of liquid level sensors which liquid level sensors are configured to detect the liquid level of the mixture and emit one or more signals receivable by the controller. The controller controls operation of the inlet valve and/or the pump to prevent a reservoir overfill condition and/or a reservoir empty condition based on the one or more received signals. In addition the container comprises a plurality of liquid level sensors configured to detect the liquid level of the composition and emit one or more signals receivable by the controller, such that the controller emits audible and/or visual alarm signals related to a detected container liquid level condition and/or interrupt the flow of the pressurized liquid.

As may be seen in FIG. 2, an embodiment of the invention is shown which is substantially the same as that depicted in FIG. 1A. Additional features of a preferred embodiment of the invention provide a top portion 94 of container 14 which top portion comprises venturi-shaped section 40 of liquid conduit 12. Container 14 is seen to be detachably attached to conduit 12 proximate to top portion 94 so that container 14 can easily be removed when empty and replaced by a full container. Also provided is a rocker switch 72 which serves to ensure that if container 14 is removed when the system is in operation, electrical connection between rocker switch 72 and inlet valve 34 will be interrupted. Inlet valve 34 will close to prevent pressurized liquid 10 from flowing into any space provided by removal of container 14.

FIG. 3 shows a preferred embodiment of the invention comprising a spray nozzle 28 comprising a check valve 68C. Check valve 68C is depicted as being integral to spray nozzle 28. Preferred settings for check valve 68C are pressures in the range of from about 80 psi to about 100 psi to prevent chatter and/or dripping of the nozzle and to prevent leakage of the mixture from the spray nozzle when the system is not in use. As shown, a spray of mixture 21 is sprayed in a fine mist to an area in need of treatment for insects. Preferred spray rates are in the range of about 1 to about 3 ounces per minute.

FIG. 4 depicts a preferred embodiment of the invention wherein the system comprises a user interface and automated controller. It is to be understood that a user interface 62 as described herein, is non-limiting in the scope of the number, types and arrangements of particular features of user interface 62. User interface 62 of automated controller 54 is shown to comprise a plurality of tactile keys 64,64 for configuring controller 54 to control at least a frequency of operation and/or a duration of operation of a pump (best seen in FIGS. 1 and 2). Automated controller 54 is also sized and configured to control, at least: (A) formation of the liquid mixture in a liquid conduit, by contacting, in the liquid conduit, a flow of pressurized liquid with a liquid chemical composition from a container; (B) storage of the liquid mixture in a reservoir; and (C) operation of a pump to dispense the liquid mixture from the reservoir to the area.

Each key 64 is associated with a corresponding visual signal display 66 which is activated when the associated key 64 is engaged by a user. Visual signal displays are depicted as light-emitting diodes (LEDs). As shown, there are 24 keys 64, 64, numbered 1-24, each representing an hour of a 24 hour period of time. One or more of the 1-24 hour keys is engaged by the user to configure the automated controller to provide spray to the area one or more times of day. For instance, if it is desired to provide spray from the spray nozzles every hour of the 24 hour period, each of the 1-24 keys would be pressed or engaged. To disengage a chosen key, the key should be pressed again. Confirmation that an associated key has been engaged is provided by the nearby LED 66 which will light if the associated key is engaged. An LED or LCD clock 82 is provided, which is configured by engaging hour key 84 and minute key 86 to set the desired, correct time of day. Manual over-ride of any preset times is made possible by engaging a manual spray key 88. Spray duration keys 90,90 are provided to provide configuration of the system to spray for a set duration. These keys can be assigned time duration values from 0.0001 second to 59.9999 minutes with preferred duration values of 5, 10, 15, 20, 30, and 45 seconds respectively or for continuous spray for up to 5 minutes. Operation of the pump will not be properly configured until at least one hour key and one duration key have been engaged. Alternate mode key 92 is also provided to switch the control protocol from, for example, spraying once on the hour (Mode I), to once on the hour and once on the half hour (Mode IIa) or to once on the hour, once at 20 minutes after the hour and once at 40 minutes after the hour (Mode IIb).

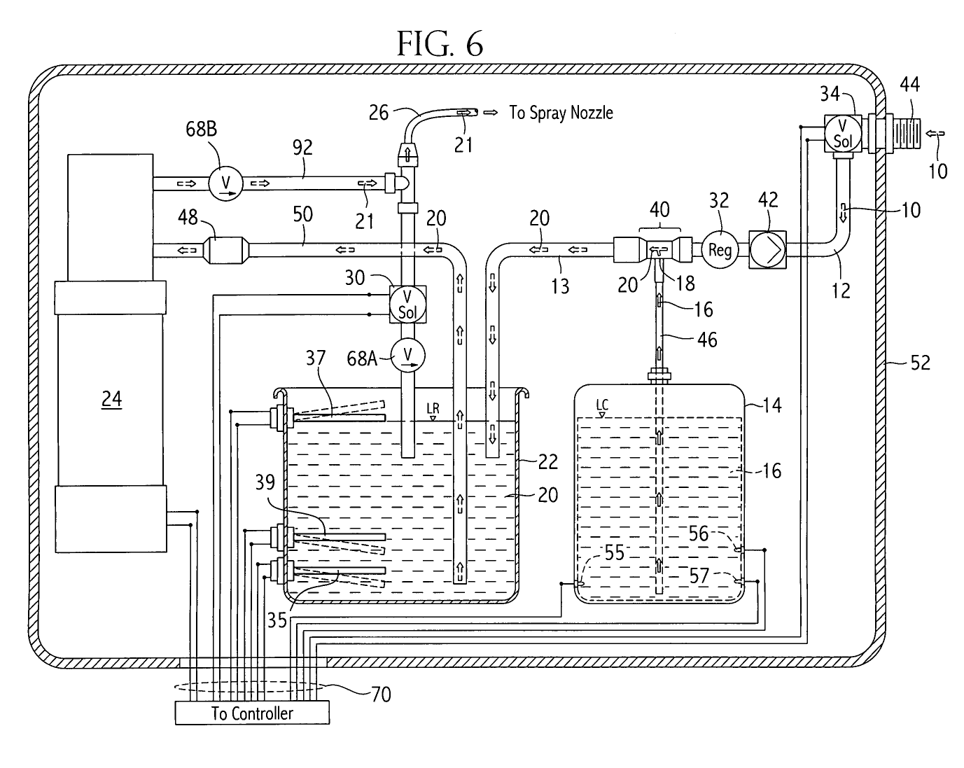

FIG. 6 illustrates the system as in FIG. 1A, but with modification to the level sensing feature. Three level control devises 35,37,39 are disposed in and along a side wall of reservoir 22 to prevent both reservoir overflow and reservoir empty conditions. Upper level control device 37, shown as a mechanical float mechanism, detects when level LR of mixture 20 reaches a pre-determined level. If level LR continues to rise beyond the horizontal configuration of upper level control device 37, upper level control device 37 deflects upward, causing an electronic signal to reach the automated controller and then deactivation of inlet valve 34 to stop flow of mixture 20 into reservoir 22. Intermediately spaced level control device 39 is electronically connected to the automated controller through circuit lines 70. Circuit lines 70 are seen in the figures linking various elements of the system. Downward deflection from horizontal of level control device 39, caused by level LR of mixture 20 dropping in reservoir 22, triggers activation of inlet valve 34 resulting in additional flow of mixture 20 into reservoir 22. Lower spaced level control device 35 acts as a fail-safe protection for pump 24. Any downward deflection of lower spaced level control device 35 from horizontal, caused by near-dry condition of reservoir 22, results in an electrical signal to automated controller to shut off pump 24. The automated controller will also emit an audible and/or visual alarm to alert the user to the undesirable condition.

The general operation of the system can be summarized as follows. To begin operation, a garden hose is connected to the water supply conduit, and water flow is initiated from the water supply. The nozzle lines are connected to the spray nozzles which have been disposed in the designated area to be treated for insect pests. Preferably between 5 and 100 spray nozzles are provided. The container of concentrated liquid chemical composition is interlocked into position or otherwise detachably attached. The system and automated controller are attached to an electrical power supply. The inlet valve is opened by a signal received from the automated controller, and flow regulated water passes though the pressurized liquid conduit and through the venturi-shaped section of the conduit, causing liquid chemical composition to be drawn into the conduit. A liquid mixture of water and chemical composition forms in the venturi-shaped section of the conduit and passes into the reservoir by way of a downstream section of the conduit. The reservoir continues to fill until the liquid level reaches the highest level sensor contact point at which time the automated controller receives the signal of the level sensor related to the detected level condition of the reservoir, and the inlet valve is caused to close by the automated controller, thus halting flow of pressurized liquid into the system.

The user configures the user interface of the controller to read the correct time, to spray at a particular time or frequency of times and to spray for some duration of time. At the appointed time or frequency of times, the automated controller causes the pump to operate to move liquid mixture out of the reservoir and dispense the mixture to the designated area through the spray nozzle(s) for the pre-selected duration of time.

Cycles of fill and draw down of the mixture from the reservoir continue as spray operation is performed according to configured, programmed entries via the user interface of the automated controller.

If water flow from the water supply gets interrupted, low level sensors send detected low level condition signals to the automated controller which acts to shut down the pump before damage is sustained. The automated controller will also emit an audible and/or visual alarm to alert the user to the undesirable condition.

Level sensors interior to or integral to the chemical composition container provide signals of low level condition to the automated controller prompting visual LEDs “Low” and/or “Empty” on the user interface to activate. In addition, a preferred embodiment of the invention provides audible low and/or empty conditions alarms to sound.

General operation instructions for configuring the automated controller by using the user interface are as follows. Power is supplied to the automated controller by attaching to a conventional 110 volt circuit. The automated controller is also provided with battery back-up as an additional fail-safe feature, so that loss of conventional power will not erase particular controller settings which have been previously entered. Batteries are installed in the automated controller at initial start-up of the system. The system will sound an audible alarm if battery power drops below a pre-configured value. The automated controller also comprises a capacitor with the capability to maintain power to maintain the clock for about 10 to about 15 seconds if both conventional power source and battery power source both fail. The only feature which will require re-configuration in any power loss situation is the resetting of the clock as all other frequency and duration settings are stored in “static memory” of the automated controller.

To set the time displaced on the user interface, press and hold the “HR” tactile key on the user interface until the correct hour is shown on the clock LED. The system utilizes military time convention, thus 12 is added to any hour after 12:00 noon to determine the appropriate tactile hour key. Press and hold the “MIN” tactile key until the correct minutes are displayed.

To select an appropriate hour of the day on which to spray the area, press the tactile key or keys for the hours of the day for which operation of the system is desired. For example, pressing the tactile key at hour “3” once, causes the associated LED light to activate, indicating that the system will operate at 3 am. To clear this entry, press the tactile key at hour “3” a second time. The associated LED will deactivate, indicating that no operation will commence at that hour. Other choices of frequency and duration are made and cleared in a similar fashion.

To select the duration of the spray, chose one of the 7 duration tactile keys, e.g. 5 sec, 10 sec, 15 sec, etc. If, for example, a 15 sec duration is chosen and configured, at the 3 o'clock hour, the system will operate to spray the area with the aqueous chemical mixture once at 3 am for a 15 second period of time, before shutting off. Pressing the “Continuous” tactile key causes the system to spray until key is pressed or until a maximum of 5 minutes has passed, whichever is shorter. Pressing the continuous key does not affect the set duration for automatic sprays.

The system also provides an immediate manual activation of the system by pressing tactile key “SPRAY” so that the system will immediately spray the area for the set duration before deactivating. When these steps are performed, the system will immediately spray the area for the set duration (15 seconds in this case) before deactivating.

The system can be configured to turn off by pressing and holding any activated duration key. In this Off mode, the clock LED displays “OFF” and all of the activated hour tactile keys with their associated LEDs will shut off. The pre-selected duration key and associated LED will remain active in the OFF mode as well as “Low” or “Empty” LEDs which may be lit (showing that the system is low or empty of chemical composition). The system can still be activated manually to spray for the set duration by pressing the “SPRAY” key unless the “Empty” LED is lit. To take the system out of OFF mode, press any tactile key other than “SPRAY” and the system will return to its previous state of configuration. The automated controller has the further novel feature of being programmable to cause the system to spray multiple sprays per hour.

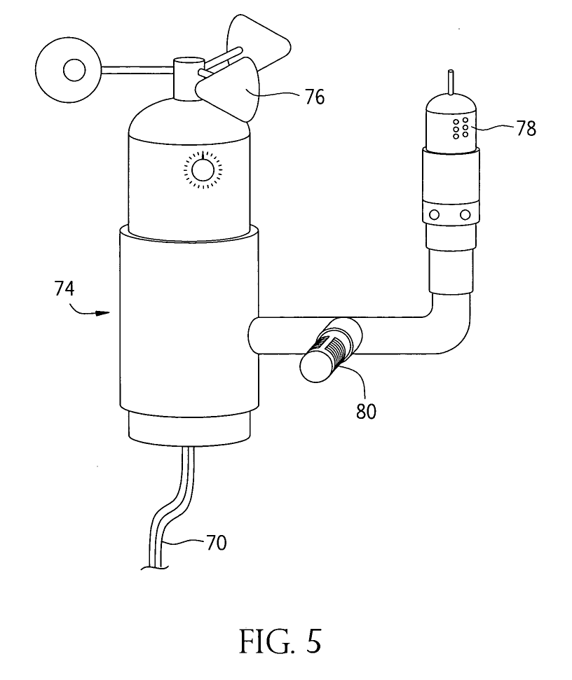

A preferred embodiment of the invention further comprises at least one environment condition sensor, best seen in FIG. 5. Such environment condition sensor can typically detect wind speed, rain occurrence, temperature or any two or more of these. As shown, environment condition sensor 74 can provide signals to the automated controller via electrical circuit lines 70, which signals relate to wind speed as detected by wind speed component 76, rain occurrence as detected by rain component 78, and ambient temperature as detected by temperature component 80. Environment condition sensor 74 is disposed in the area proximate to the one or more spray heads. Signals received by the automated controller from environmental condition sensor 74 can allow the controller to shut down the system in response to adverse weather conditions such as high wind, rain and/or freezing temperatures. In this way the system can be more economically operated, for instance, to prevent dispensing of the mixture during high wind conditions when the mixture would be rapidly scattered without having sufficient contact time in the area to have the desired effect on the insect population.

Other optional features of the invention comprise two styles of remote control devices for the system. One remote control device option is a wired remote device such as a conventional doorbell mechanism which connects through a jack on the side of the automated controller. Activation of the doorbell mechanism remote device by pushing the doorbell button results in an activation of the system to spray for the pre-set duration. This wired remote device can be conveniently located at some distance from the other components of the system, such as having the system and spray nozzles located in a patio area and having the wired remote device located inside the home. An optional second remote control device is a radio frequency handheld remote transmitter which interacts with the automated controller having a receiver to allow remote access to the control options. Various alarm configuration options are also provided which allow choice of timing and deactivation steps for alarms in response to low level or empty level conditions of the chemical composition.

Each and every patent, publication, or commonly-owned patent application referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove. Rather, what is intended to be covered is as set forth in the ensuing claims and the equivalents thereof permitted as a matter of law.

1. A system for applying a liquid chemical mixture to an area, which system comprises:
(A) a liquid conduit for supplying a flow of pressurized liquid to the system, which pressurized liquid enters the conduit through an inlet valve;
(B) a container for a liquid chemical composition, which container is in fluid communication with the conduit so that the composition contacts the pressurized liquid in the conduit to form the mixture;
(C) a reservoir in fluid communication with the conduit, which reservoir is configured to receive and store the mixture;
(D) at least one spray nozzle, through which spray nozzle, the mixture is dispensed to the area;
(E) a pump in fluid communication with the reservoir and with the spray nozzle, which pump forces the mixture through the spray nozzle; and
(F) an automated controller which is configured to at least (i) control operation of the inlet valve and (ii) control operation of the pump.

2. A system according to claim 1 further comprising a dump valve in fluid communication with the spray nozzle and with the reservoir, which dump valve is sized and configured to relieve pressure on the spray nozzle by allowing the mixture to flow from the spray nozzle into the reservoir when the system is not in use.

3. A system according to claim 1 wherein the spray nozzle comprises a check valve to prevent leakage of the mixture from the spray nozzle when the system is not in use.

4. A system according to claim 1 wherein the liquid conduit comprises a venturi-shaped section for forming a vacuum therein, which vacuum causes the composition to be drawn from the container into the conduit when there is flow of pressurized liquid in the conduit.

5. A system according to claim 4 wherein a top portion of the container comprises the venturi-shaped section of the liquid conduit and wherein the container is detachably attached to the conduit proximate to the top portion of the container.

6. A system according to claim 1 wherein
I. the reservoir comprises a plurality of liquid level sensors which liquid level sensors are configured to detect the liquid level of the mixture and emit one or more signals receivable by the controller, such that the controller controls operation of the inlet valve and/or the pump to prevent a reservoir overfill condition and/or a reservoir empty condition based on the one or more received signals, and/or
II. the container comprises a plurality of liquid level sensors configured to detect the liquid level of the composition and emit one or more signals receivable by the controller, such that the controller emits audible and/or visual alarm signals related to a detected container liquid level condition and/or interrupt the flow of the pressurized liquid.

7. A system according to claim 1 wherein the controller controls a frequency and/or a duration of spray of the mixture.

8. A system according to claim 1 wherein the system further comprises at least one environment condition sensor which detects (a) wind speed (b) rain occurrence (c) temperature or (d) any two or more of the foregoing, which environment condition sensor emits at least one environment signal detectable by the controller, whereby the controller controls operation of the system based on the environment signal detected.

9. A system according to claim 1 wherein the pressurized liquid used is water.

10. A system according to claim 1 wherein the liquid chemical composition is an insecticide.

11. A method for dispensing a liquid chemical mixture to an area, which method comprises:
(A) introducing a flow of pressurized liquid through an inlet valve into a liquid conduit;
(B) placing the liquid conduit in fluid communication with a container for a liquid chemical composition, which container is sized and configured such that the composition contacts the pressurized liquid and forms the mixture in the liquid conduit as the pressurized liquid flows though the liquid conduit;
(C) moving the mixture so formed into a reservoir in fluid communication with the liquid conduit;
(D) periodically pumping the mixture from the reservoir through at least one spray nozzle into the area by use of a pump, which pump is in fluid communication with the reservoir and with the spray nozzle; and
(E) controlling at least operation of the inlet valve and the pump by use of an automated controller.

12. A method according to claim 11 further comprising relieving pressure on the spray nozzle when the pump is not in use such that the mixture flows back into the reservoir by use of a dump valve in fluid communication with the spray nozzle and with the reservoir.

13. A method according to claim 11 further comprising configuring the controller to receive signals from:
I. a plurality of liquid level sensors disposed within or integral to the reservoir, which liquid level sensors are configured to detect at least one liquid level of the mixture and emit one or more signals receivable by the controller, such that the controller controls operation of the inlet valve and/or the pump to prevent a reservoir overfill condition and/or a reservoir empty condition based on the one or more received signals; and/or
II. a plurality of liquid level sensors disposed in or integral to the container, which liquid level sensors are configured to detect at least one liquid level of the chemical composition and emit one or more signals receivable by the controller, such that the controller (a) emits audible and/or visual alarm signals related to a detected container liquid level condition, (b) interrupt the flow of pressurized liquid when the detected container liquid level condition reflects an insufficient amount of chemical composition, (c) prevents operation of the pump, or (d) any two or more of the foregoing.

14. A method according to claim 11 further comprising configuring the controller to control a frequency of operation and/or a duration of operation of the pump.

15. A method according to claim 11 wherein the pressurized liquid used is water.

16. A method according to claim 11 wherein the liquid chemical composition is an insecticide.

17. A method according to claim 11 wherein the liquid conduit comprises a venturi-shaped section for forming a vacuum therein, which vacuum causes the composition to be drawn from the container into the conduit when there is flow of pressurized liquid in the conduit.

18. A method according to claim 17 wherein a top portion of the container comprises the venturi-shaped section of the liquid conduit and wherein the container is detachably attached to the conduit proximate to the top portion of the container.
